(19) United States
(12) Patent Application Publication
(10) Pub. No.: US 2026/0288945 A1
(43) Pub. Date: Sep. 24, 2026

(54) MANAGING A BOOT PARTITION OF A STORAGE DEVICE USING A MANAGEMENT CONTROLLER

(71) Applicant: Dell Products L.P., Round Rock, TX (US)

(72) Inventors: XIAOMEI ZHU MILLER, Round Rock, TX (US); ADOLFO SANDOR MONTERO, Pflugerville, TX (US); PHANINDRA BHARGAV TALASILA, Georgetown, TX (US); IBRAHIM SAYYED, Georgetown, TX (US)

(21) Appl. No.: 19/085,688

(22) Filed: Mar. 20, 2025

(51) Int. Cl. G06F 21/55

(52) U.S. Cl. CPC G06F 21/554; G06F 2221/034

(57) ABSTRACT

Methods and systems for managing operation of a data processing system are disclosed. To do so, a management controller of the data processing system may identify replacement of a first storage device with a second storage device. In addition, boot data that was stored in a first boot partition of the first storage device may not be stored in the second storage device. A copy of the boot data may be obtained from a trusted entity and used to initiate, by the management controller and via side band channels, performance of a boot partition synchronization process to store the copy of the boot data in a second boot partition of the second storage device. The copy of the boot data may be used to place the data processing system in a desired operating state and computer-implemented services may be provided by the data processing system in the desired operating state.

### FIELD

Embodiments disclosed herein relate generally to managing operation of a data processing system. More particularly, embodiments disclosed herein relate to managing a boot partition of a storage device using a management controller.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1C show diagrams illustrating a system in accordance with an embodiment.

FIGS. 2A-2C show interaction diagrams in accordance with an embodiment.

FIGS. 3A-3C show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing systems may provide computer-implemented services to any type and number of other devices and/or users of the data processing systems. The computer-implemented services may include any quantity and type of such services.

To provide the computer-implemented services, a data processing system may perform a booting process to initialize operation of hardware resources hosted by the data processing system. To do so, a processor (e.g., a central programming unit (CPU)) of the hardware resources may utilize boot data (e.g., basic input/output system (BIOS) firmware, system configuration files, etc.) that may be stored on a boot storage device. The boot storage device may include, for example, a non-volatile memory storage device (e.g., serial peripheral interface flash).

To protect against loss of the boot data (e.g., due to corruption of the boot storage device, due to physical damage to the boot storage device), a copy of the boot data may be stored in a boot partition of a storage device. The storage device may be a non-volatile memory (NVMe) storage device that may include a boot partition (e.g., a section of the storage device allocated to store data relevant to the booting process). Therefore, in the event of loss of boot data stored in the boot storage device, the boot data may be restored using the copy of the boot data stored in the boot partition of the storage device.

However, the storage device may be replaced with a new storage device over time. The boot data (e.g., and/or other data critical to the booting process that may have been stored in the boot partition of the storage device) may not be stored on the new storage device and, therefore, the boot data may not be recoverable using the second storage device If the boot data is not able to be recovered, a booting process (e.g., a startup) may not be performed for the data processing system, the data processing system may boot in an undesirable operating state, and/or computer-implemented services may not be provided as desired (e.g., to users of the data processing system).

To increase a likelihood of providing the desired computer-implemented services following replacement of a first storage device with a second storage device, a copy of the boot data may be obtained from a trusted entity (e.g., a remote server). A management controller of the data processing system may initialize performance of a boot partition synchronization process for the second storage device to store the copy of the boot data in a second boot partition of the second storage device. By doing so, the copy of the boot data may be available for use (e.g., during a future startup for the data processing system, to recover lost and/or corrupted boot data stored in the boot storage device) to place the data processing system in a desired operating state.

Thus, embodiments disclosed herein may provide an improved method for managing operation of a data processing system by synchronizing boot data stored by a newly added storage device with known good boot data stored by a trusted entity. By doing so, a processor of the data processing system may be more likely to perform a successful booting process using the boot data to provision desired computer-implemented services provided by the data processing system.

In an embodiment, a method for managing operation of a data processing system is provided. The method may include: making an identification, by a management controller of the data processing system, that a first storage device of hardware resources of the data processing system has been replaced with a second storage device, and that boot data that was stored in a first boot partition of the first storage device is not stored in the second storage device; based on the identification: obtaining a copy of the boot data from a trusted entity; initiating, by the management controller and via side band channels of the data processing system, performance of a boot partition synchronization process to store the copy of the boot data in a second boot partition of the second storage device; using the copy of the boot data to place the data processing system in a desired operating state; and providing, by the data processing system in the desired operating state, computer-implemented services.

Making the identification may include: obtaining, by the management controller, an intrusion detection alert indicating that the first storage device has been replaced with the second storage device; in response to the intrusion detection alert: obtaining, by the management controller and via a first side band channel of the side band channels, identifying information from the second storage device; making a first determination, by the management controller and using the identifying information, regarding whether an identity of the second storage device is expected; and in a first instance of the first determination in which the identity of the second storage device is not expected: concluding that the boot partition synchronization process is to be performed for the second storage device.

Making the identification may also include: in a second instance of the first determination in which the identity of the second storage device is expected: making a second determination regarding whether the second storage device comprises the boot data; and in a first instance of the second determination in which the second storage device does not comprise the boot data: concluding that the boot partition synchronization process is to be performed for the second storage device.

The boot data may include at least one type of data selected from a list of types of data consisting of: an image of a startup manager of the data processing system; and system configuration files.

Initiating performance of the boot partition synchronization process may include: making a determination, by the management controller, regarding whether the second boot partition exists in the second storage device; in an instance of the determination in which the second boot partition exists in the second storage device: transmitting, by the management controller and via a first side band channel of the side band channels, the copy of the boot data to the second boot partition for storage; and in a second instance of the determination in which the second boot partition does not exist in the second storage device: cooperatively, by the management controller and the second storage device, creating the second boot partition in the second storage device; and transmitting, by the management controller, the copy of the boot data to the second boot partition for storage.

The method may also include: prior to making the identification: obtaining, based on the boot data stored in the first boot partition of the first storage device, the copy of the boot data; and providing the copy of the boot data to the trusted entity for storage by the trusted entity as a backup for contents of the first boot partition.

The copy of the boot data may be obtained from the trusted entity via an out of band communication channel by the management controller.

The data processing system may include a network module adapted to separately advertise network endpoints for the management controller and the hardware resources of the data processing system, the network endpoints being usable by the trusted entity to address communications to the hardware resources using an in-band communication channel and the management controller using the out of band communication channel.

The management controller may operate independently from and may be distinct from the hardware resources.

The management controller may be on a separate power domain from the hardware resources so that the management controller may be operable while the hardware resources may be inoperable.

The hardware resources may include a processor and the storage device. The hardware resources may be operably connected by in-band channels used during general operation of the data processing system to provide the computer-implemented services.

The management controller may be operably connected to at least the processor and the storage device by the side band channels. The side band channels may be used to manage operation of the data processing system and the side band channels may not be used to provide the computer-implemented services.

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

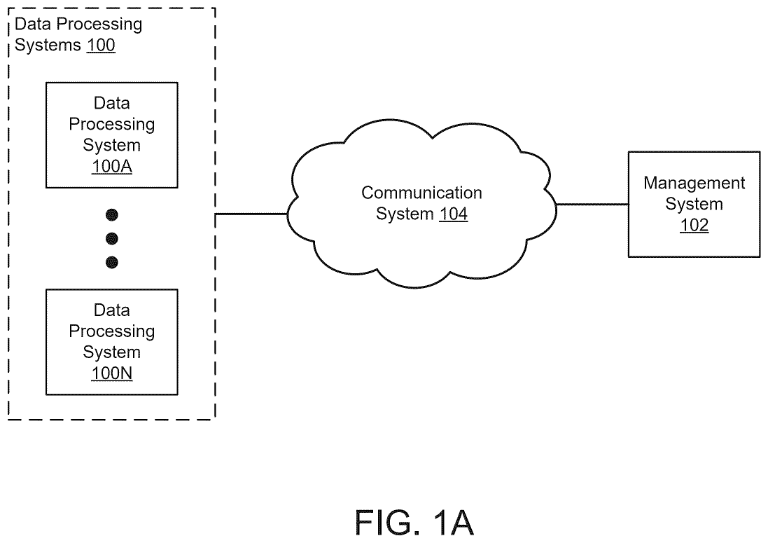

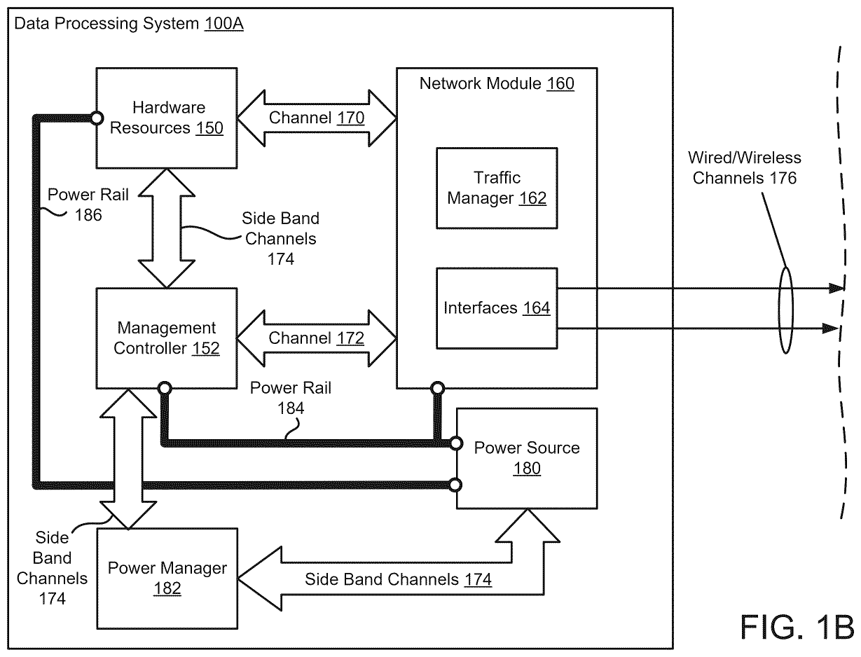

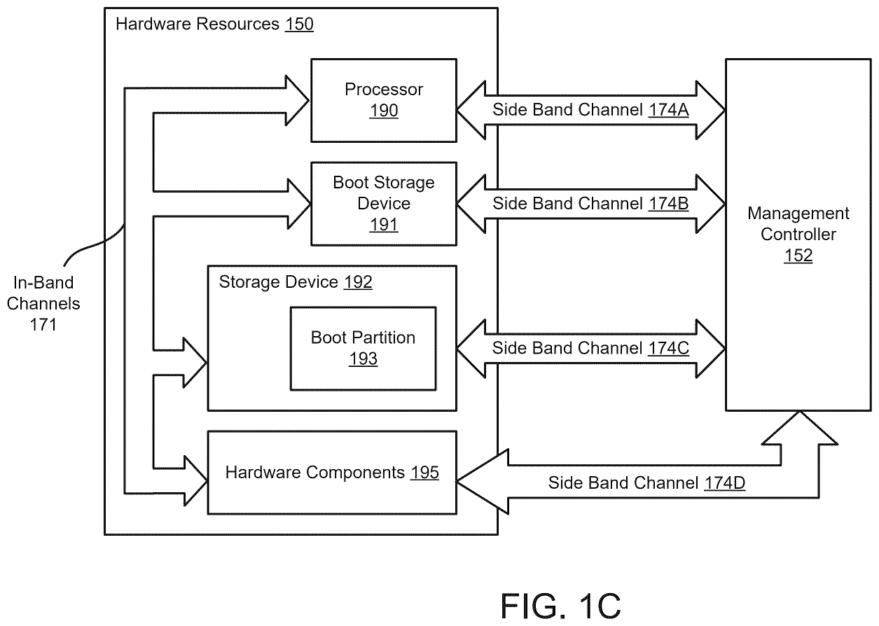

Turning to FIG. 1A, a block diagram illustrating a system in accordance with an embodiment is shown. The system shown in FIG. 1A may provide for management of data processing systems that may provide, at least in part, computer-implemented services (e.g., to users of the system and/or devices operably connected to the system).

The system may include any number of data processing systems 100 (e.g., computing devices) that may each include any number of hardware components (e.g., processors, memory modules, storage devices, communication devices, etc.). The hardware components may support execution of any number and types of applications (e.g., software components). Changes in available functionalities of the hardware and/or software components may provide for various types of different computer-implemented services to be provided over time. Refer to FIG. 1B for additional details regarding data processing systems 100.

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, data processing systems 100, management system 102, and/or any other type of devices (not shown in FIG. 1A). Other types of computer-implemented services may be provided by the system shown in FIG. 1A without departing from embodiments disclosed herein.

The computer-implemented services may be provided at least in part, by hardware resources of data processing systems 100. To provide the computer-implemented services, a data processing system may perform a booting process to initialize operation of the hardware resources. To do so, a processor (e.g., a central programming unit (CPU)) of the hardware resources may utilize boot data (e.g., basic input/output system (BIOS) firmware, system configuration files, etc.) that may be stored on a boot storage device. The boot storage device may include, for example, a non-volatile memory storage device (e.g., serial peripheral interface flash).

By performing the booting process, the hardware resources of the data processing system may be operably connected to each other (e.g., via in-band channels) and an operating system may be loaded to provide management functionality.

To guard against loss of the boot data (e.g., due to data corruption, due to malicious attacks, due to physical damage to hardware components of the data processing system), at least the boot data may also be stored in a storage device of the hardware components of the data processing system. The storage device may be a non-volatile memory (NVMe) storage device that may include a boot partition (e.g., a section of the storage device allocated to store data relevant to the booting process). By storing at least the boot data in the storage partition (e.g., along with other boot critical information), the boot data may be recoverable in an event of data loss of the boot storage device.

However, the storage device (e.g., a first storage device) may be replaced over time with a new storage device (e.g., a second storage device). For example, an owner of a data processing system may purchase the second storage device (e.g., to increase storage capacity of the data processing system, due to malfunction of the first storage device). The boot data may not be stored on the second storage device and, therefore, the boot data may be unavailable if a data loss event occurs for the boot storage device. Consequently, the data processing system may be placed in an undesirable operating state following a future startup for the data processing system (e.g., due to hardware components and/or software components not being initialized as desired).

In general, embodiments disclosed herein relate to systems, devices, and methods for managing operation of a data processing system using a management controller. The management controller may manage operation of hardware components of the data processing system via side band channels (e.g., side band communication channels) of the data processing system and/or may interact with other entities via an out of band channel (e.g., an out of band communication channel) as part of managing the operation of the data processing system.

To manage the operation of the data processing system, the management controller may identify that a first storage device has been replaced with a second storage device (e.g., via obtaining an intrusion detection alert). The management controller may also identify that the boot data is not stored in the second storage device. Therefore, the management controller may initiate performance of a boot partition synchronization process to store a copy of the boot data in a second boot partition of the second storage device.

To do so, a copy of the boot data may be obtained from a trusted entity (e.g., a server owned by a vendor and/or a manufacturer) and used to perform the boot partition synchronization process. For example, the management controller may obtain the copy of the boot data from the trusted entity via an out of band channel. The management controller may transmit, via a first side band channel of the side band channels, the copy of the boot data to a second boot partition of the second storage device for storage.

During a future booting process (e.g., startup process) for the data processing system, the copy of the boot data may be used to place the data processing system in a desired operating state and computer-implemented services may be provided based on the desired operating state.

Thus, by storing a copy of the boot data in the second storage device, the copy of the boot data may be available for use in: (i) recovering lost data stored in the boot storage device, (ii) verifying integrity of one or more hardware components of the data processing system, and/or (iii) other purposes.

To provide the above noted functionality, the system may include data processing systems 100, and management system 102. Each of these components is discussed below.

Data processing systems 100 may include any number of data processing systems (e.g., 100A-100N) that may individually and/or cooperatively provide at least a portion of the computer-implemented services. Any of data processing systems 100 may include in-band components (e.g., hardware resources), out of band components (e.g., management controller, network modules, etc.), and functionality that may allow the out of band components to communicate with management system 102 via an out of band communication channel.

While providing the at least a portion of the computer-implemented services, a data processing system (e.g., 100A) of data processing systems 100 may communicate with and/or obtain information from management system 102. For example, data processing system 100A may obtain: (i) instructions relevant to updated boot software (e.g., an updated firmware version), (ii) management requests to modify operation of the hardware resources (e.g., installing new applications), (iii) copies of boot data for data processing system 100A, and/or (iv) any other information. Data processing system 100A may subsequently perform actions based on the information obtained from management system 102 to update operation of data processing system 100A.

Management system 102 may, as discussed above, provide remote management services. Management system 102 may include, for example, a second data processing system operated by a trusted entity (e.g., a manufacturer of data processing system 100A, a vendor for at least a portion of hardware components of data processing system 100A). To provide the remote management services, management system 102 may host a server that stores any amount of information relevant to operation of data processing systems 100. For example, management system 102 may generate and provide a copy of boot data to a data processing system of data processing systems 100 for use in performing a boot partition synchronization process following replacement of a storage device of the data processing system.

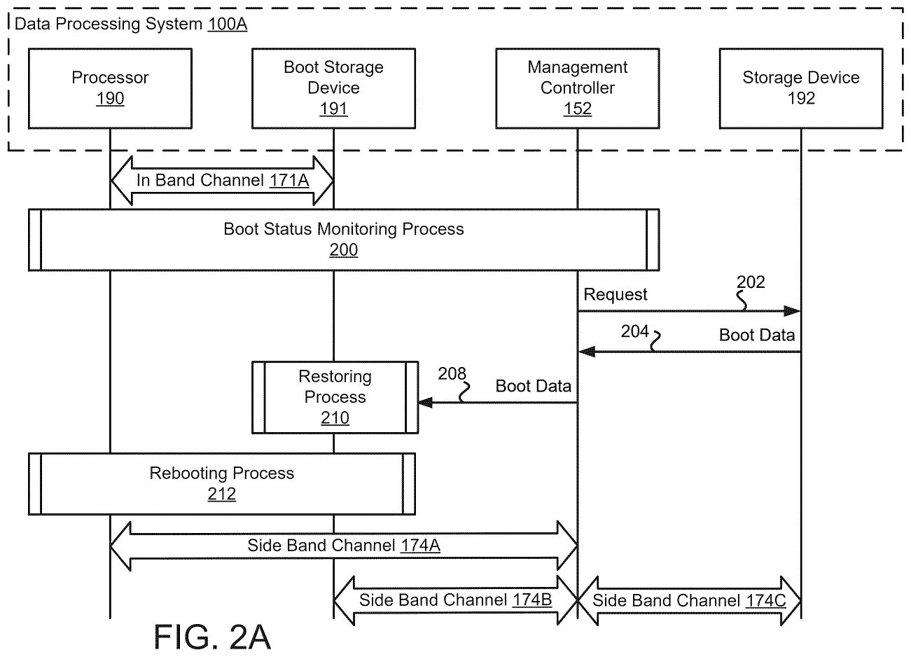

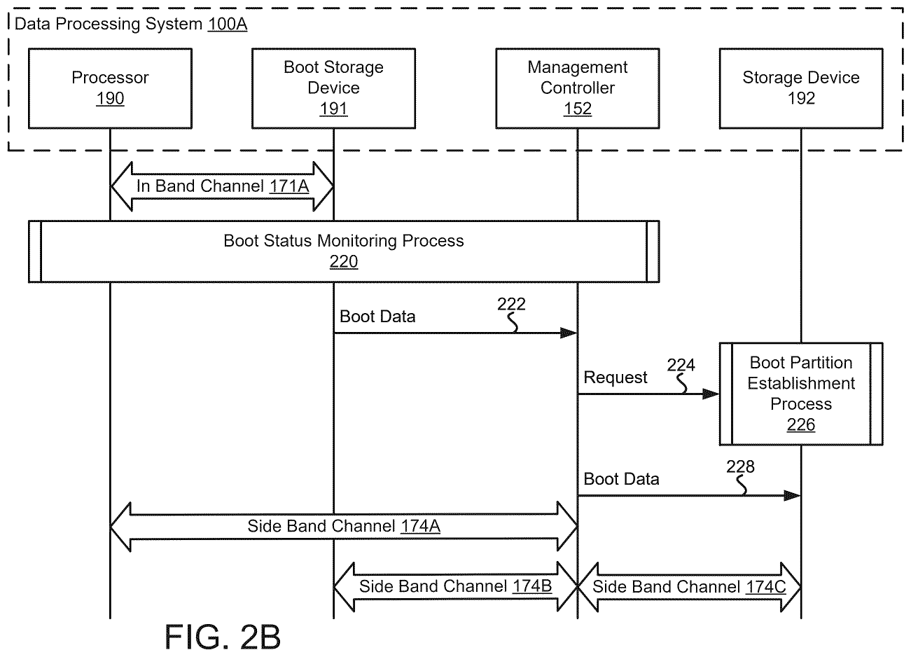

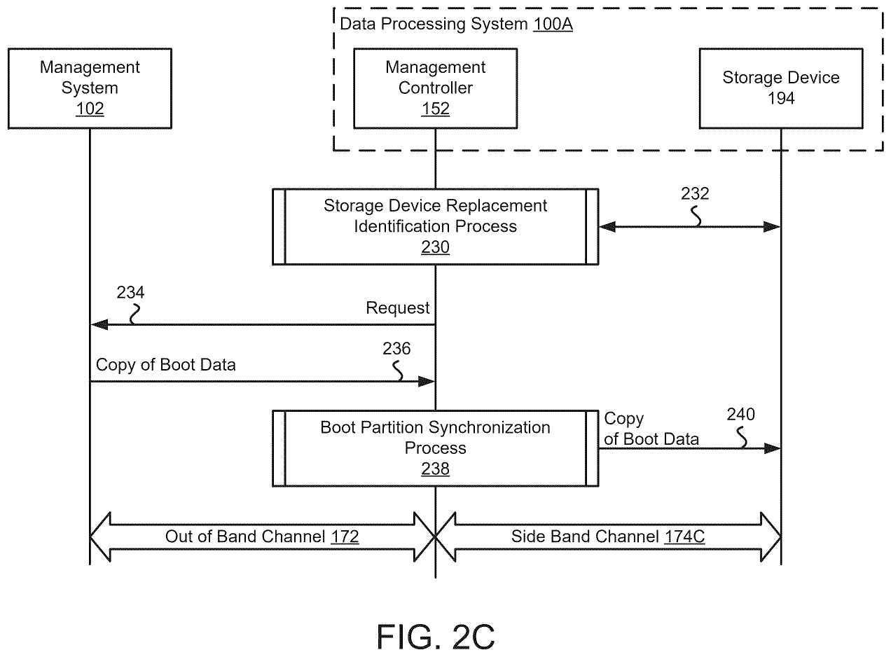

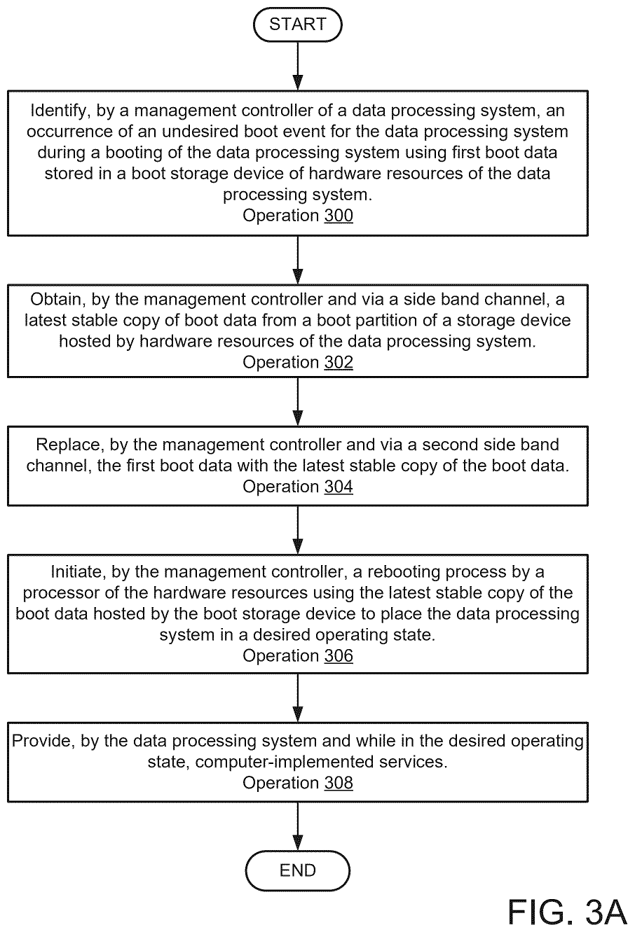

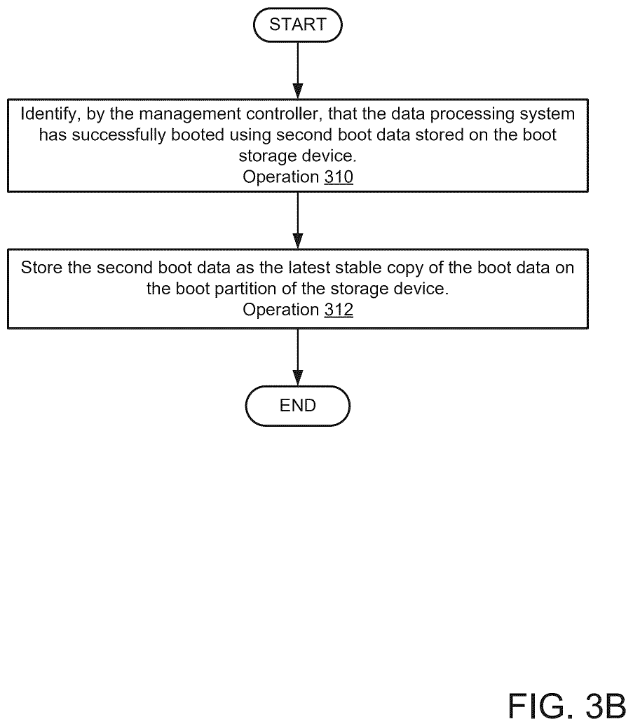

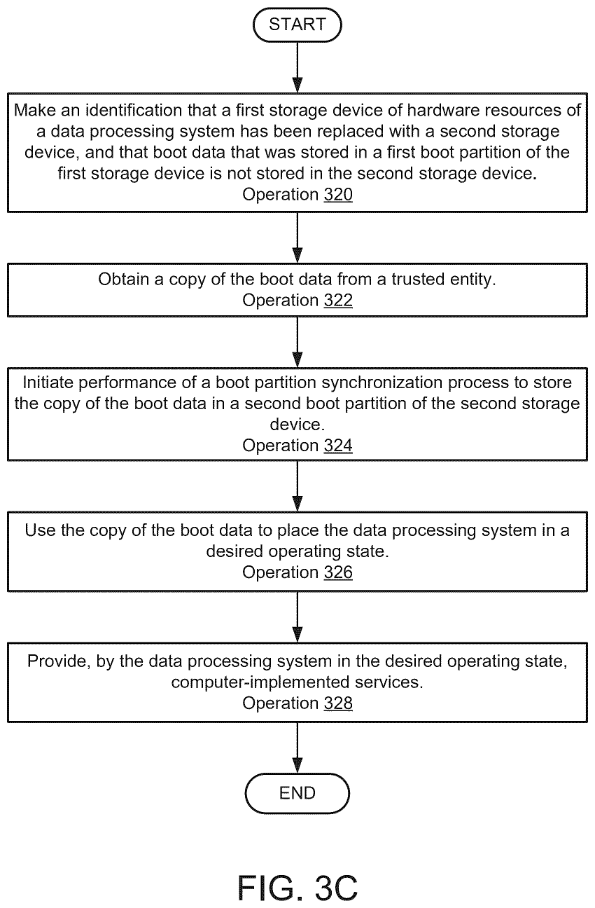

While providing their functionality, any of data processing systems 100, and management system 102 may provide all or a portion of the methods shown in FIGS. 2A-3C.

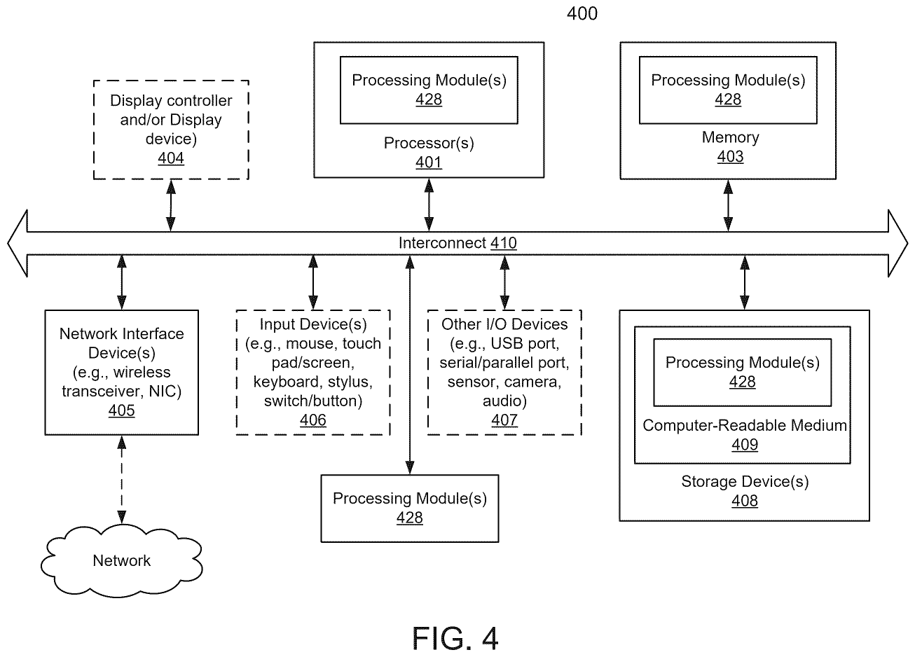

Communication system 104 may allow any of data processing systems 100, and management system 102 to communicate with one another (and/or with other devices not illustrated in FIG. 1A). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to management system 102 via the Internet. Data processing systems 100, management system 102, and/or communication system 104 may be adapted to perform one or more protocols for communicating via communication system 104.

Any of (and/or components thereof) data processing systems 100, and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1A, a system in accordance with an embodiment may manage operation of a data processing system by synchronizing a copy of boot data stored by management system 102 with contents of a boot partition of a storage device of the data processing system. By doing so, a likelihood of placing the data processing system in a desired operating state may be increased thereby increasing a likelihood of providing desired computer-implemented services.

While illustrated in FIG. 1A with a limited number of specific components, a system may include additional, fewer, and/or different components without departing from embodiments disclosed herein.

Turning to FIG. 1B, a diagram illustrating a data processing system in accordance with an embodiment is shown. Data processing system 100A shown in FIG. 1B may be similar to any of the data processing systems shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components.

The storage may include any number and/or types of storage devices (e.g., hard drives, solid state drives, etc.). A storage device of the storage devices may include, for example, memory (e.g., non-volatile memory), a controller that may manage data operations (e.g., storage, retrieval, organization, etc.), and/or other physical components. The storage device may support storage protocols (e.g., non-volatile memory express) that may facilitate use of storage resources of the storage device.

For example, the storage may include a boot storage device adapted to host boot data (e.g., an image of a startup management entity (e.g., basic input/output system (BIOS)), system configurations, and/or any other information). Additionally, the storage may include a storage device that may include, but not be limited to, storage for information necessary to boot the data processing system, load an operating system for the data processing system, and/or perform any other processes.

The processor may host various management entities such as operating systems, drivers, network stacks, and/or other software entities that provide various management functionalities. For example, the operating system and drivers may provide abstracted access to various hardware resources.

To facilitate communication, hardware resources 150 may host a network stack that may facilitate packaging, transmission, routing, and/or other functions with respect to exchanging data with other devices. For example, the network stack may support transmission control protocol/internet protocol communication (TCP/IP) (e.g., the Internet protocol suite) thereby allowing hardware resources 150 to communicate with other devices via packet switched networks and/or other types of communication networks.

The processor may also host various applications that provide the computer-implemented services. The applications may utilize various services provided by the management entities and use (at least indirectly) the network stack to communication with other entities.

However, use of the network stack and the services provided by the management entities may place the applications at risk of indirect compromise. For example, if any of these entities trusted by the applications are compromised, these entities may subsequently compromise the operation of the applications. Additionally, if various drivers and/or the communication stack are compromised, communications to/from other devices may be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100A) to another device via any number of intermediate networks (e.g., via wired/wireless channels 176 that are part of the networks).

To reduce the likelihood of the applications and/or other in-band entities from being indirectly compromised, data processing system 100A may include management controller 152 and network module 160. Each of these components of data processing system 100A is discussed below.

Management controller 152 may be implemented, for example, using a system on a chip or other type of independently operating computing device (e.g., independent from the in-band components, such as hardware resources 150, of a host data processing system 100A). Management controller 152 may provide various management functionalities for data processing system 100A. For example, management controller 152 may monitor various ongoing processes performed by the in-band components, may manage power distribution, thermal management, and/or other functions of data processing system 100A.

To provide the management functionalities, management controller 152 may utilize data that may, at least temporarily be stored on storage resources hosted by management controller 152. For example, management controller may download an image of a new management entity (e.g., firmware, application, etc.) in response to a management request, store the image, and install the new management entity using at least the image on hardware resources 150.

Because an ability of management controller 152 to provide the management functionalities may be limited when the data exceeds storage capacity of storage resources hosted by the management controller, management controller 152 may utilize any number and/or types of storage devices hosted by hardware resources 150.

To do so, management controller 152 may be operably connected to various components via side band channels 174 (in FIG. 1B, a limited number of side band channels are included for illustrative purposes, it will be appreciated that management controller 152 may communication with other components via any number of side band channels). The side band channels may be implemented using separate physical channels, and/or with a logical channel overlay over existing physical channels (e.g., logical division of in-band channels). The side band channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities. Side band channels 174 may not be used during general operation of the data processing system to provide the computer-implemented services (e.g., to users of data processing system 100A).

For example, management controller 152 may: (i) identify, via a first side band channel of side band channels 174, that a first storage device of hardware resources 150 has been replaced with a second storage device of hardware resources 150, (ii) identify, via the first side band channel, that boot data that was stored in the first storage device is not stored in the second storage device, (iii) initiate, via the first side band channel, performance of a boot partition synchronization process to store a copy of the boot data in a second boot partition of the second storage device, and/or (iv) perform other management functionalities via side band channels 174.

Management controller 152 may be operably connected to communication components of data processing system 100A via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted component may not result in indirect compromise of any management controller 152, and entities hosted by management controller 152.

For example, storage devices of hardware resources 150 may not be operably connected to a processor (e.g., due to in-band channels between the processor and the storage devices not being functional during the booting process). Management controller 152 may communicate with the processor, the boot storage device, and the storage device via side band channels 174. By doing so, management controller 152 may obtain and perform management functionalities (e.g., detecting a system hang during booting, obtaining data from a storage device, transmit a copy of boot data to the boot storage device, etc.) regardless of an operating state of hardware resources 150.

To facilitate communication with other devices, data processing system 100A may include network module 160. Network module 160 may provide communication services for in-band components and out of band components (e.g., management controller 152) of data processing system. To do so, network module 160 may include traffic manager 162 and interfaces 164.

Traffic manager 162 may include functionality to (i) discriminate traffic directed to various network endpoints advertised by data processing system 100A, and (ii) forward the traffic to/from the entities associated with the different network endpoints. For example, to facilitate communications with other devices, network module 160 may advertise different network endpoints (e.g., different media access control address/internet protocol addresses) for the in-band components and out of band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out of band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out of band components of data processing system 100A may appear to be two independent network entities, that may independently addressable, and otherwise unrelated to one another.

To facilitate management of data processing system 100A over time, hardware resources 150, management controller 152 and/or network module 160 may be positioned in separately controllable power domains. By being positioned in these separately controllable power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100A may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 that is supplied to the power rails. Management controller 152 may cooperate with power manager 182 to manage supply of power to these power domains.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

When providing its functionality, management controller 152 may perform all, or a portion, of the methods and operations illustrated in FIGS. 2A-3C.

While illustrated in FIG. 1B with a limited number of specific components, a system may include additional, fewer, and/or different components without departing from embodiments disclosed herein.

Turning to FIG. 1C, to provide computer-implemented services, hardware resources 150 may host processor 190, boot storage device 191, storage device 192 and hardware components 195 (e.g., other hardware components of hardware resources 150). For example, to place a data processing system (e.g., 100A) in a desired operating state, data processing system 100A may perform a booting process to initialize hardware resources and facilitate operation of an operating system. To do so, processor 190 may execute instructions indicated by boot data (e.g., firmware, system configuration, etc.) hosted by boot storage device 191.

Boot storage device 191 may include, for example, non-volatile flash memory (e.g., serial peripheral interface (SPI) flash) that may be hosted on a motherboard and adapted to store information, such as firmware, an image of a management entity (BIOS, universal extensible firmware interface (UEFI), etc.), system configuration files, and/or any other information usable to boot data processing system 100A. Because boot storage device 191 may have a limited storage capacity, storage device 192 may be used to store additional information (e.g., other copies of boot data).

Storage device 192 may include, for example, a non-volatile memory express (NVMe) based solid-state drive. Storage device 192 may include a boot partition (193) that may be configured to store data usable to boot data processing system 100A (e.g., a latest stable copy of boot data, bootloader files, configuration files, etc.). Boot partition 193 may include an allocated section of storage device 192 that may, for example, be isolated from other memory sections of storage device 192.

Over time, hardware components of hardware resources 150 may be replaced (e.g., storage device 192 may be replaced with a new storage device). The new storage device (not shown) may also be an NVMe based solid-state drive. However, the boot data may not be stored on the new storage device. The new storage device, for example, may not include a boot partition.

In response to identifying that storage device 192 has been replaced with the new storage device (e.g., a second storage device), management controller 152 may: (i) obtain identifying information for the second storage device via side band channel 174C, (ii) determine whether an identity of the second storage device is expected (e.g., by comparing the identifying information to a list of expected device identifiers). If the second storage device is expected, management controller 152 may determine whether the second storage device includes the boot data (e.g., performing a signature verification process data structures stored by the second storage device, performing a hash checking process to check contents of data stored by the second storage device). If the second storage device does not include the boot data, management controller 152 may conclude that a boot partition synchronization process is to be performed for the second storage device.

If the second storage device is not expected, management controller 152 may conclude that the boot partition synchronization process is to be performed for the second storage device. Refer to FIG. 2C for details regarding performing the boot partition synchronization process.

Processor 190 may include a central processing unit (CPU) that may interact with any number and/or type of other hardware components (e.g., boot storage device 191, storage device 192, and hardware components 195). For example, when data processing system 100A is powered on, processor 190 may be initialized to a predetermined state and directed to retrieve instructions (e.g., via a reset vector) from boot storage device 191. To interact with boot storage device 191, storage device 192, and/or the other hardware components, processor 190 may be operably connected to each of the components via in-band channels 171. In-band channels 171 may be used during general operation of data processing system 100A to provide the computer-implemented services.

However, at least a portion of in-band channels 171 may not be functional and/or may have reduced functionality during booting of data processing system 100A and/or as a result of an undesired boot event. For example, in an event that storage device 192 and/or hardware components 195 are not initialized during booting, processor 190 may not be able to communicate with storage device 192 to obtain a copy of boot data (e.g., a backup copy, a recovery file, etc.) for use in rebooting and placing data processing system 100A in a desired operating state.

Thus, to improve a likelihood that data processing system 100A may be booted and placed in the desired operating state, management controller 152 may perform management functionalities using any number and/or type of side band channels (e.g. 174). For example, management controller may obtain information (e.g., telemetry data, process results, boot times, etc.) regarding a boot status from processor 190 using side band channel 174A, replace a copy of undesired boot data hosted by boot storage device 191 with a latest stable copy of boot data using side band channel 174B, read and/or write boot data to boot partition 193 of storage device 192 using side band channel 174C, and/or perform any other actions by communicating with components of hardware resources regardless of a boot status of data processing system 100A.

To further clarify embodiments disclosed herein, interaction diagrams in accordance with an embodiment are shown in FIGS. 2A-2C. The interaction diagrams may illustrate how data may be obtained and used within the system of FIGS. 1A-1C.

In the interaction diagrams, processes performed by and interactions between components of a system in accordance with an embodiment are shown. In the diagrams, components of the system are illustrated using a first set of shapes (e.g., 190, 191, etc.), located towards the top of each figure. Lines descend from these shapes. Processes performed by the components of the system are illustrated using a second set of shapes (e.g., 200, 210, etc.) superimposed over these lines. Interactions (e.g., communication, data transmissions, etc.) between the components of the system are illustrated using a third set of shapes (e.g., 202, 204, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the process labeled as 200 may occur prior to the interaction labeled as 202. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may occur during rebooting of a data processing system when an undesired boot event is identified to have occurred during booting of the data processing system.

To identify that an undesired boot event has occurred, boot status monitoring process 200 may be performed. During boot status monitoring process 200, processor 190 may attempt to boot data processing system 100A using boot data hosted by boot storage device 191, and management controller 152 may monitor the booting process via a side band communication channel. For example, processor 190 may attempt to boot data processing system 100A by receiving a reset signal (e.g., via a power-on process), initializing registers, retrieving data (e.g., BIOS, UEFI, etc.) stored on boot storage device 191 via in-band channel 171A, attempting to execute instructions (e.g., firmware code) based on the data, and/or performing any other actions.

While attempting to boot, processor 190 may be operably connected to boot storage device 191 via in-band channel 171A but may not operably connected to storage device 192 (and/or any other hardware components). In-band channel 171A may include, for example, a limited communication channel between processor 190 and boot storage device 191 that may be facilitated using a signal multiplexer that may enable processor 190 to communicate with boot storage device 191 (e.g., using a system bus) while limiting communication with the other hardware components prior to a management entity (e.g., an operating system, drivers, etc.) being loaded as a result of a successful booting.

Accordingly, management controller 152 may monitor and/or obtain information from processor 190 using side band channel 174A. For example, management controller 152 may obtain data (e.g., telemetry data) from processor 190, compare the data to criteria (e.g., a boot timeout time), and determine that an undesired boot event (e.g., a system hang) has occurred. Based on the identification that an undesired boot event has occurred, management controller may restore a latest stable copy of boot data to boot storage device 191.

At interaction 202, a request may be provided to storage device 192 by management controller 152. The request may be transmitted to storage device 192 via side band channel 174C. The request may indicate, for example, a request to read boot data (e.g., an image of a management entity, firmware, system configuration files, etc.), an identifier for the boot data, a logical block address (e.g., of a boot partition), and/or any other information.

At interaction 204, the boot data may be provided to management controller 152 by storage device 192. For example, the boot data may be provided by: (i) locating the requested boot data (e.g., on the boot partition of storage device 192), (ii) transferring the requested boot data to management controller via side band channel 174C and/or using a data transfer protocol (e.g., non-volatile memory express, universal serial bus, etc.), and/or via any other processes. The boot data may include a version of boot data used during a last successful booting performed for data processing system 100A. Refer to FIG. 2B for additional information regarding obtaining the latest stable copy of the boot data.

Once obtained, the latest stable copy of the boot data may be stored, at least temporarily, by management controller 152. Additionally, management controller 152 may verify at least a portion of the boot data. For example, management controller 152 may verify an integrity of the data (e.g., firmware, system configuration files, etc.).

At interaction 208, the boot data may be provided to boot storage device 191 by management controller 152. For example, the boot data may be provided by transmitting the latest stable copy of the boot data along with instructions (e.g., a write request) via side band channel 174B, utilizing a firmware interface, and/or via any other processes.

To restore the latest stable copy to boot storage device 191, restoring process 210 may be performed. During restoring process 210, a copy of boot data (e.g., that may include erroneous data causing the undesired boot event) hosted by boot storage device 191 may be replaced with the latest stable copy of the boot data. To do so, the existing boot data stored on boot storage device 191 may be removed (e.g., deleted from the non-volatile memory), the latest stable copy of boot data may be written to memory of boot storage device 191, boot storage device 191 be flashed using the latest stable copy of boot data, and/or any other actions may be performed.

Once restored, rebooting process 212 may be performed to attempt to boot data processing system 100A using the latest stable copy of the boot data while hosted on boot storage device 191. Rebooting process 212 may be initiated by management controller 152, as a result of a configuration (e.g., based on an update to storage resources hosted by boot storage device 191), and/or via any other mechanisms. During rebooting process 212, processor 190 may retrieve the boot data from boot storage device 191, execute instructions (e.g., firmware code) based on the boot data, initialize hardware resources, and provide control to a management entity.

By executing the instructions based on the latest stable copy of the boot data, processor 190 may perform operations that may place data processing system 100A in a desired state (e.g., during the last successful booting using the version of the boot data). For example, software and/or hardware resources may be validated (e.g., during a power on self-test), the hardware resources may be configured and/or initialized based on the boot data, an operating system may be loaded to memory of data processing system 100A (e.g., using a bootloader), and/or any other actions may be performed.

Side band channels (e.g., 174A-C) may be used to facilitate communication between management controller 152 and storage device 192, and are shown to indicate that management controller 152 may interface with processor 190, boot storage device 191, and storage device 192 regardless of a status of in-band channels (e.g., that may have reduced functionality due to the undesired boot event). Using the side band channels, management controller 152 may perform management commands that may include, for example, accessing secured data, providing instructions to use the data, obtaining information regarding an operating state of hardware resources 150, installing management entities on hardware resources 150 using the data, and/or performing any other actions.

Thus, using processes and interactions shown in FIG. 2A, a latest stable copy of boot data may be restored, using a management controller, on a boot storage device and used to boot a data processing system in an event that the data processing system is unable to boot using first boot data stored on the boot storage device. By doing so, the data processing system may be placed in a desired operating state for providing computer-implemented services.

Turning to FIG. 2B, a second interaction diagram in accordance with an embodiment is shown. The second interaction diagram may illustrate processes and interactions that may occur during storing of a latest stable copy of boot data used to boot a data processing system.

To store the latest stable copy of boot data, boot status monitor process 220 may be performed. During boot status monitoring process 220, data processing system 100A may be booted, and information regarding the booting may be obtained by management controller 152. For example, data processing system 100A may be booted by: (i) retrieving, by processor 190, the boot data (e.g., image of a management entity, system configuration files, etc.) from boot storage device 191, (ii) executing instructions indicated by the boot data, (iii) initializing hardware resources (e.g., loading firmware-level drivers), (iv) validating a state of the hardware resources, (v) loading an operating system into memory, and/or via any other processes.

During the booting, management controller 152 may obtain information (e.g., telemetry data, processing results, etc.) from processor 190 via side band channel 174A. Based on the information, management controller 152 may identify that the booting was successful (e.g., the operating system was loaded to memory), boot data (e.g., image of management entity, system configurations, etc.) used during booting was updated from a previous version of boot data. and/or any other information.

At interaction 222, boot data may be obtained by management controller 152 from boot storage device 191. The boot data may include, for example, an updated copy of an image of a management entity, system configuration files, firmware, and/or any other information. To obtain the boot data, management controller 152 may transmit a request to access the boot data stored on boot storage device 191 via side band channel 174, the boot data may be transferred to management controller using a communication protocol (e.g., serial peripheral interface) that may be supported by boot storage device 191, the boot data may be transmitted based on an operating system configuration, and/or via any other processes. Once obtained, the boot data may be stored, at least temporarily, by management controller 152.

At interaction 224, a request to store the boot data in a boot partition may be provided to storage device 192 from management controller 152. The request may include, for example, an address for the boot partition if determined by management controller 152 that the boot partition exists, a request to write data to the boot partition, and/or any other information. If determined that the boot partition does not exist, the request may also indicate to storage device that the boot partition is to be created.

To create the boot partition on storage device 192, boot partition establishment process 226 may be performed. During boot partition establishment process 226, a portion of storage resources of storage device 192 may be allocated for boot data. For example, to allocate the portion of storage resources, a size of a partition (e.g., a logical partition) may be configured, the portion of storage resources may be formatted, and/or any other actions may be performed to establish the boot partition. Once established, the boot partition (e.g., 193) may store boot data that may be isolated from other data stored on storage device 192.

At interaction 228, the boot data may be provided to boot partition 193 of storage device 192 for storage. For example, the latest stable copy of boot data may be stored on the boot partition by (i) issuing, by management controller 152, a write request to storage device 192 via side band channel 174C, (ii) identifying, by storage device 192, a physical storage location (e.g., a flash memory cell) for the boot partition, (iii) writing the boot data to the storage location, and/or performing any other actions.

Thus, using processes and interactions shown in FIG. 2B, boot data used during a last successful booting of a data processing system may be stored in a boot partition of a storage device hosted by the data processing system. By doing so, the boot data may be obtained, by a management controller, when an undesired boot event is identified during a future booting of the data processing system and used to initiate a new booting of the data processing system to place the data processing system in a desired operating state.

Turning to FIG. 2C, a third interaction diagram in accordance with an embodiment is shown. The third interaction diagram may illustrate processes and interactions that may occur following replacement of a storage device of a data processing system.

For example, storage device 192 (e.g., described in FIG. 1C) may be replaced in data processing system 100A with storage device 194 (e.g., an owner of data processing system 100A may remove storage device 192 from data processing system 100A and add storage device 194). Storage device 194 may be operably connected to management controller 152 by side band channel 174C.

Following the replacement of storage device 192 with storage device 194, management controller 152 may perform storage device replacement identification process 230. Storage device replacement identification process 230 may include interactions with storage device 194 via side band channel 174C (e.g., interaction 232). For example, at interaction 232, management controller 152 may obtain identifying information (e.g., a device identifier, storage capacity specifications, configuration settings) from storage device 194 and may use the identifying information to determine whether an identity of storage device 194 is expected.

To do so, management controller 152 may compare the identifying information to a list of expected devices (e.g., stored by management controller 152, stored in another location of data processing system 100A, obtained from another entity). If the identity of storage device 194 is not expected (e.g., is not listed as an expected and, therefore, trusted device), management controller 152 may conclude that a boot partition synchronization process is to be performed for storage device 194.

If the identity of storage device 194 is expected (e.g., storage device 194 may be storage device 192 following removal, potential modification, and re-installation as storage device 194), management controller 152 may determine whether the boot data is stored in storage device 194.

To do so, during storage device replacement identification process 230, management controller may perform a signature and hash checking process for data stored by storage device 194. For example, management controller 152 may request, via side band channel 174C, a data package from storage device 194. The data package may be requested to include a signed data structure (e.g., a certificate signed by a trusted entity using a private key of a public private key pair maintained by the trusted entity). A payload of the signed data structure may include at least a portion of data stored by storage device 194, a hash of the contents of the storage device 194, and/or other information.

Management controller 152 may obtain the data package via side band channel 174C (e.g., as part of interaction 232) and may perform a signature verification process (e.g., using a public key of the public private key pair maintained by the trusted entity) and/or a hash matching process for the contents of storage device 194 using a known good copy of the boot data.

If the signature and/or hash is unable to be verified, management controller 152 may determine that the contents of storage device 194 are not acceptable and that the boot partition synchronization process is to be performed. If no data package is obtained from storage device 194, management controller 152 may also conclude that the boot partition synchronization process is to be performed.

If the hash matching and signature verification process are successful, management controller 152 may conclude that storage device 194 is in an acceptable operating state and may conclude that the boot partition synchronization process is not to be performed.

If management controller 152 concludes that the boot partition synchronization process (e.g., boot partition synchronization process 238) is to be performed, management controller may provide, at interaction 234, a request to management system 102. Management system 102 may include a server hosted by a trusted entity (e.g., a vendor and/or a manufacturer for one or more components of data processing system 100A). Management system 102 may store a copy of the boot data that was stored in boot partition 193.

For example, the request may be generated and provided to management system 102 via (i) transmission via a message, (ii) storing in a storage with subsequent retrieval by management system 102, (iii) via a publish-subscribe system where management system 102 subscribes to updates from management controller 152 thereby causing a copy of the request to be propagated to management system 102, and/or via other processes. Management controller 152 may transmit the request over out of band channel 172 thereby bypassing in-band communication channels of data processing system 100A. Refer to FIG. 1B for additional details regarding out of band channels.

At interaction 236, a management system 102 may provide a copy of the boot data to management controller 152. For example, the copy of the boot data may be generated and provided to management controller 152 via (i) transmission via a message, (ii) storing in a storage with subsequent retrieval by management controller 152, (iii) via a publish-subscribe system where management controller 152 subscribes to updates from management system 102 thereby causing a copy of the copy of the boot data to be propagated to management controller 152, and/or via other processes. Management system 102 may transmit the copy of the boot data over out of band channel 172 thereby addressing the copy of the boot data to a network endpoint associated with management controller 152 and subsequently bypassing the in-band channels of data processing system 100A.

It may be appreciated that interactions 234 and 236 may occur prior to and/or during storage device replacement identification process 230 (e.g., prior to performing the hash matching process) without departing from embodiments disclosed herein.

Management controller 152 may perform at least a portion of boot partition synchronization process 238 to store the copy of the boot data in a second boot partition of storage device 194. To initiate boot partition synchronization process 238, management controller 152 may determine whether storage device 194 includes the second boot partition (e.g., management controller 152 may request storage architecture information from storage device 194 (not shown) via side band channel 174C). If storage device 194 does not include the second boot partition, management controller and storage device 194 may cooperatively create the second boot partition in storage device 194 (e.g., refer to boot partition establishment process 226 in FIG. 2B for details regarding similar methods for establishing the second boot partition in storage device 194).

Following creation of the second boot partition (or if the second boot partition is determined to already exist), management controller 152 may transmit the copy of the boot data to storage device 194 at interaction 240 (e.g., via side band channel 174C). By transmitting the copy of the boot data to storage device 194, storage device 194 may be modified to include the desired boot data. For example, if the second boot partition includes other data (e.g., not the desired boot data), the other data may be deleted and the copy of the boot data may be written to the boot partition. If the second boot partition includes no data, the copy of the boot partition may be stored in the second boot partition.

While described with respect to management controller 152 performing boot partition synchronization process 238, it may be appreciated that other entities may perform at least a portion of boot partition synchronization process 238. For example, management controller 152 may provide information and/or instructions related to performing boot partition synchronization process 238 to a startup manager of data processing system 100A (e.g., a basic input/output system (BIOS)). The startup manager may retrieve the copy of the boot data from management system 102 and/or may provide the copy of the boot data to storage device 194 for storage.

Thus, using processes and interactions shown in FIG. 2C, boot data may be available in a second boot partition of a second storage device. By doing so, the boot data stored in the second boot partition may include at least a backup copy of boot data if boot data stored in a boot storage device is corrupted and/or unavailable in the boot storage device. Consequently, a likelihood that data processing system 100A may be placed in a desired operating state following a future startup using the boot data may be increased and, therefore, a likelihood of providing computer-implemented services in the desired operating state may be increased.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-1C may perform various methods to manage a data processing system. FIGS. 3A-3C illustrate methods that may be performed by the components of the system of FIGS. 1A-1C. In the diagrams discussed below and shown in FIGS. 3A-3C, any of the operations may be repeated, performed in different orders, and/or performed in parallel with or in a partially overlapping in time manner with other operations.

Turning to FIG. 3A, a first flow diagram illustrating a method of managing operation of a data processing system in accordance with an embodiment is shown. The method may be performed, for example, by any of the components of the system of FIGS. 1A-1C, and/or other components not shown therein.

Prior to operation 300, a latest stable copy of boot data used during a last successful booting of the data processing system may be stored in a boot partition of a storage device of hardware resources of the data processing system. The latest stable copy of boot data may include, for example, a first version of boot data (e.g., image of a management entity, system configuration files, firmware, etc.), an updated version of the first version of boot data, and/or any other information. Refer to FIG. 3B for additional information regarding obtaining the latest stable copy of the boot data.

At operation 300, an occurrence of an undesired boot event for the data processing system during a booting of the data processing system may be identified. The occurrence of the undesired boot event may be identified by a management controller of the data processing system. Because in-band channels may have limited functionality during the booting and/or as a result of the undesired boot event, the management controller may obtain information (e.g., telemetry data, results of processes performed, etc.) regarding the booting from a processor of the data processing system using a side band channel. For example, management controller 152 may detect that a system hang (e.g., a boot timeout) based on the information.

At operation 302, the latest stable copy of boot data may be obtained from the boot partition by the management controller and using a side band channel. The latest stable copy of boot data may be obtained by: (i) transmitting a read request (e.g., an identifier, file address, etc.) to the storage device for the latest stable copy of boot data, (ii) locating, by the storage device, the requested latest stable copy of boot data, (iii) transmitting the latest stable copy of the boot data via the side band channel and/or using a data transfer protocol (e.g., NVMe), validating an integrity of the latest stable copy of the boot data, and/or via any other processes.

At operation 304, the first boot data hosted by the boot storage device may be replaced with the latest stable copy of the boot data. The first boot data may be replaced by: (i) flashing boot storage device (e.g., an SPI flash storage device) with the latest stable copy of boot data, (ii) erasing the first boot data from the boot storage device and writing the latest stable copy of the boot data to the boot storage device, (iii) overwriting the first boot data with the latest stable copy of the boot data, and/or performing any other actions. To do so, management controller may communicate with the boot storage device using a second side band channel.

At operation 306, a rebooting process may be initiated by the management controller for a processor using the latest stable copy of the boot data. The rebooting process may be initiated by: (i) sending a reset signal to the processor, (ii) triggering a new booting process based on an update to the boot storage device, (iii) executing instructions indicated by the latest stable copy of the boot data, (iv) loading an operating system into memory of the data processing system, and/or performing any other actions to place the data processing system in a desired operating state.

At operation 308, computer-implemented services may be provided by the data processing system and while in the desired operating state. The computer-implemented services may be provided by: (i) installing a new management entity (e.g., an application, driver, firmware etc.), (ii) providing an interface for a user of the data processing system, and/or via any other processes.

The method may end following operation 308.

Using the method shown in FIG. 3A, operation of a data processing system may be managed using a management controller to restore boot data hosted by a boot storage device in an event that an undesired boot event is identified during an attempted booting of the data processing system. By doing so, the data processing system may be booted to a desired operating state.

Turning to FIG. 3B, a second flow diagram illustrating a method of storing a latest stable copy of boot data to a boot partition of a storage device is shown. The method may be performed, for example, by any of the components of the system of FIGS. 1A-1C, and/or other components not shown therein.

At operation 310, it may be identified by the management controller that the data processing system has successfully booted using boot data stored on the boot storage device. The management controller may identify that the data processing system has successfully booted by: (i) monitoring a boot status via a side band communication channel between the management controller and the processor, (ii) obtaining telemetry data from the processor, (iii) identifying execution of an operating system kernel, and/or via any other processes.

At operation 312, the second boot data may be stored as the latest stable copy of the boot data on a boot partition of a storage device. The latest stable copy of the boot data may be stored by: (i) identifying whether a boot partition exists on the storage device, (ii) cooperatively, between the management controller and the storage device, allocating a portion of storage resources of the storage device to create the boot partition in an instance where the boot partition does not exist, (iii) issuing, by the management controller, a write request to the storage device to store the latest stable copy of the boot data to the boot partition, and/or via any other processes.

The method may end following operation 312.

Using the method shown in FIG. 3B, a boot data used by the data processing system during a last successful booting may be identified by a management controller and stored in a boot partition of a storage device. By doing so, the boot data may be used by the management controller to replace undesired boot data during a future attempted booting of the data processing system.

Turning to FIG. 3C, a third flow diagram illustrating a method of performing at least a boot partition synchronization process is shown. The method may be performed, for example, by any of the components of the system of FIGS. 1A-1C, and/or other components not shown therein.

Prior to the methods in FIG. 3C (e.g., prior to operation 320), a copy of boot data may be obtained based on boot data stored in a first boot partition of a first storage device of hardware resources of the data processing system. The copy of the boot data may be obtained, for example, in response to a firmware update (e.g., updated firmware may be installed from a third party vendor and may not be known by other entities that host copies of the boot data), based on a boot data backup schedule (e.g., copies of the boot data may be synchronized across multiple storage locations once per day), and/or for other reasons. Obtaining the copy of the boot data may include: (i) reading the copy of the boot data from the first boot partition of the storage device, (ii) receiving the copy of the boot data from another entity, and/or (iii) other methods.

The copy of the boot data may be provided to a trusted entity for storage by the trusted entity as a backup for contents of the first boot partition. Providing the copy of the boot data to the trusted entity may include: (i) generating a data package that includes the copy of the boot data, (ii) transmitting the data package (e.g., by a management controller of the data processing system via an out of band channel, by another entity), and/or (iii) other methods. Therefore, the copy of the boot data may be retrievable via an interaction with the trusted entity if boot data stored by the data processing system is lost, corrupted, or otherwise unavailable.

At operation 320, an identification may be made that: (i) a first storage device of hardware resources of the data processing system has been replaced with a second storage device and (ii) boot data that was stored in a first boot partition of the first storage device is not stored in the second storage device.

Making the identification may include: (i) obtaining an intrusion detection alert indicating that the first storage device has been replaced with the second storage device, (ii) obtaining (e.g., in response to the intrusion detection alert) identifying information from the second storage device, (iii) determining, using the identifying information, whether an identity of the second storage device is expected, (iv) if the identity is not expected, concluding that a boot partition synchronization process is to be performed for the second storage device, and/or (v) other methods.

Obtaining the intrusion detection alert may include: (i) obtaining a notification that a chassis intrusion occurred while the data processing system was depowered (e.g., upon initiation of a startup and from a chassis intrusion switch), (ii) obtaining a notification from another entity (e.g., a startup manager) indicating that a startup for the data processing system was interrupted due to a chassis intrusion event, and/or (iii) other methods.

Obtaining the identifying information from the second storage device may include: (i) requesting (e.g., by a management controller via a side band channel) the identifying information from the storage device, (ii) reading the identifying information from any storage component of the data processing system, (iii) receiving the identifying information from another entity, and/or (iv) other methods.

Determining whether the identity of the second storage device is expected may include: (i) obtaining a list of expected devices of the data processing system, (ii) parsing the identifying information to obtain a device identifier for the second storage device, (iii) comparing the device identifier (and/or other portions of the identifying information) to the list of expected devices to determine whether the second storage device is an expected device, and/or (iv) other methods.

For example, the second storage device may be an expected storage device if: (i) the device identifier for the second storage device is included in the list of expected devices (e.g., the second storage device has been verified as trusted, the second storage device was purchased from a trusted vendor and verified), (ii) the device identifier for the second storage device indicates that the second storage device is the first storage device (e.g., the second storage device and the first storage device have a same device identifier), and/or (iii) other criteria are met.

The second storage device may be the first storage device if the first storage device is removed from the data processing system and reinstalled to the data processing system. The second storage device may be a modified, repaired, and/or unaltered version of the first storage device.

The second storage device may not be expected if the device identifier for the second device does not match any of the list of the expected devices. Concluding that the boot partition synchronization process is to be performed for the second storage device may include: (i) generating a log entry in an event log indicating that the boot partition synchronization process is to be performed, (ii) notifying another entity (e.g., a startup manager) that the boot partition synchronization process is to be performed, and/or (iii) other methods.

If the identity is expected, making the identification may include: (i) determining whether the second storage device includes boot data, (ii) if the second storage device does not include the boot data, concluding that the boot partition synchronization process is to be performed for the second storage device, and/or (iii) other methods.

Determining whether the second storage device includes the boot data may include: (i) obtaining a data package from the second storage device (e.g., by the management controller and via a side band channel) that includes a cryptographically verifiable data structure, (ii) performing a signature verification process using a signature included in the data package (e.g., a signature generated using a private key of a public private key pair maintained by a trusted entity) using a corresponding public key of the public private key pair to determine whether the trusted entity generated the signature, (iii) performing a hash matching process for the boot data (e.g., obtaining a copy of data stored by the second storage device, computing a hash of the copy of the data, comparing the hash of the copy of the data to a known good hash of the boot data previously stored by the first boot partition of the first storage device), and/or (iv) other methods.

Concluding that the boot partition synchronization process is to be performed may include: (i) generating a log entry in an event log indicating that the boot partition synchronization process is to be performed, (ii) notifying another entity (e.g., a startup manager) that the boot partition synchronization process is to be performed, and/or (iii) other methods.

At operation 322, a copy of the boot data may be obtained from a trusted entity. The trusted entity may be: (i) a manufacturer of the data processing system, (ii) a vendor for a hardware component of the data processing system, (iii) a server operated by a manufacturer and/or (iii) another entity. Obtaining the copy of the boot data may include: (i) sending a request for the copy of the boot data to the trusted entity (e.g., a message over an out of band channel, refer to interaction 234 in FIG. 2C), (ii) receiving, in response to the request, the copy of the boot data (e.g., refer to interaction 236 in FIG. 2C), and/or (iii) other methods.

At operation 324, performance of a boot partition synchronization process may be initiated to store a copy of the boot data in a second boot partition of the second storage device. Initiating the performance of the boot partition synchronization process may include: (i) determining whether the second boot partition exist in the second storage device, (ii) if the second boot partition exists in the second storage device, transmitting the copy of the boot data to the second boot partition for storage, and/or (iii) other methods.

Determining whether the second boot partition exists in the second storage device may include: (i) providing (e.g., by a management controller and via a side band channel) a request to the second storage device for a list of partitions of the second storage device and obtaining, in response to the request, a response including the list of partitions, (ii) parsing the list of partitions to determine whether the second boot partition is included in the list of partitions, (iii) reading the list of partitions from storage, and/or (iv) other methods.

Transmitting the copy of the boot data to the second boot partition for storage may include methods similar to those described with respect to interaction 228 in FIG. 2B.

If the second boot partition does not exist in the second storage device, initiating performance of the boot partition synchronization process may include: (i) creating the second boot partition in the second storage device, (ii) transmitting the copy of the boot data to the second boot partition for storage, and/or (iii) other methods.

Creating the second boot partition in the second storage device may include methods similar to those described with respect to boot partition establishment process 226 in FIG. 2B.

Transmitting the copy of the boot data to the second boot partition for storage may include methods similar to those described with respect to interaction 228 in FIG. 2B.

At operation 326, the copy of the boot data may be used to place the data processing system in a desired operating state. Using the boot data to place the data processing system in the desired operating state may include: (i) sending a reset signal to a processor of the data processing system, (ii) triggering a re-booting process, (iii) executing instructions indicated by the boot data, (iv) loading an operating system into memory of the data processing system, and/or (v) performing any other actions to place the data processing system in a desired operating state.

At operation 328, computer-implemented services may be provided by the data processing system in the desired operating state. Providing the computer-implemented services may include: (i) providing a user access to data stored by the data processing system, (ii) providing the user with access to functionality of hardware and/or software resources of the data processing system, and/or (iii) other methods.

The method may end following operation 328.

Thus, using the method shown in FIG. 3C, a boot partition synchronization process may be performed following replacement of a first storage device with a second storage device so that boot data is stored in a second boot partition of the second storage device. By doing so, the boot data may be available for use as a backup for boot data stored in a boot storage device and/or may be used during a future booting process (e.g., if the boot data is not stored in the boot storage device or is corrupted) thereby placing the data processing system in the desired operating state.

Any of the components illustrated in FIGS. 1A-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device.

For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as Vx Works.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
making an identification, by a management controller of the data processing system, that a first storage device of hardware resources of the data processing system has been replaced with a second storage device, and that boot data that was stored in a first boot partition of the first storage device is not stored in the second storage device;
based on the identification:
obtaining a copy of the boot data from a trusted entity;
initiating, by the management controller and via side band channels of the data processing system, performance of a boot partition synchronization process to store the copy of the boot data in a second boot partition of the second storage device;
using the copy of the boot data to place the data processing system in a desired operating state; and
providing, by the data processing system in the desired operating state, computer-implemented services.

2. The method of claim 1, wherein making the identification comprises:
obtaining, by the management controller, an intrusion detection alert indicating that the first storage device has been replaced with the second storage device;
in response to the intrusion detection alert:
obtaining, by the management controller and via a first side band channel of the side band channels, identifying information from the second storage device;
making a first determination, by the management controller and using the identifying information, regarding whether an identity of the second storage device is expected; and
in a first instance of the first determination in which the identity of the second storage device is not expected:
concluding that the boot partition synchronization process is to be performed for the second storage device.

3. The method of claim 2, wherein making the identification further comprises:
in a second instance of the first determination in which the identity of the second storage device is expected:
making a second determination regarding whether the second storage device comprises the boot data; and
in a first instance of the second determination in which the second storage device does not comprise the boot data:
concluding that the boot partition synchronization process is to be performed for the second storage device.

4. The method of claim 1, wherein the boot data comprises at least one type of data selected from a list of types of data consisting of:
an image of a startup manager of the data processing system; and
system configuration files.

5. The method of claim 1, wherein initiating performance of the boot partition synchronization process comprises:
making a determination, by the management controller, regarding whether the second boot partition exists in the second storage device;
in an instance of the determination in which the second boot partition exists in the second storage device:
transmitting, by the management controller and via a first side band channel of the side band channels, the copy of the boot data to the second boot partition for storage; and
in a second instance of the determination in which the second boot partition does not exist in the second storage device:
cooperatively, by the management controller and the second storage device, creating the second boot partition in the second storage device; and
transmitting, by the management controller, the copy of the boot data to the second boot partition for storage.

6. The method of claim 1, further comprising:
prior to making the identification:
obtaining, based on the boot data stored in the first boot partition of the first storage device, the copy of the boot data; and
providing the copy of the boot data to the trusted entity for storage by the trusted entity as a backup for contents of the first boot partition.

7. The method of claim 1, wherein the copy of the boot data is obtained from the trusted entity via an out of band communication channel by the management controller.

8. The method of claim 7, wherein the data processing system comprises a network module adapted to separately advertise network endpoints for the management controller and the hardware resources of the data processing system, the network endpoints being usable by the trusted entity to address communications to the hardware resources using an in-band communication channel and the management controller using the out of band communication channel.

9. The method of claim 1, wherein the management controller operates independently from and is distinct from the hardware resources.

10. The method of claim 9, wherein the management controller is on a separate power domain from the hardware resources so that the management controller is operable while the hardware resources are inoperable.

11. The method of claim 1, wherein the hardware resources comprise:
a processor, and
a boot storage device, and
wherein the hardware resources are operably connected by in-band channels used during general operation of the data processing system to provide the computer-implemented services.

12. The method of claim 11, wherein the management controller is operably connected to at least the processor and the boot storage device by the side band channels, the side band channels being used to manage operation of the data processing system and the side band channels not being used to provide the computer-implemented services.

13. A non-transitory machine-readable medium having instructions stored therein, which when executed by a processor, cause the processor to perform operations for managing operation of a data processing system, the operations comprising:
making an identification, by a management controller of the data processing system, that a first storage device of hardware resources of the data processing system has been replaced with a second storage device, and that boot data that was stored in a first boot partition of the first storage device is not stored in the second storage device;
based on the identification:
obtaining a copy of the boot data from a trusted entity;
initiating, by the management controller and via side band channels of the data processing system, performance of a boot partition synchronization process to store the copy of the boot data in a second boot partition of the second storage device;
using the copy of the boot data to place the data processing system in a desired operating state; and
providing, by the data processing system in the desired operating state, computer-implemented services.

14. The non-transitory machine-readable medium of claim 13, wherein making the identification comprises:
obtaining, by the management controller, an intrusion detection alert indicating that the first storage device has been replaced with the second storage device;
in response to the intrusion detection alert:
obtaining, by the management controller and via a first side band channel of the side band channels, identifying information from the second storage device;
making a first determination, by the management controller and using the identifying information, regarding whether an identity of the second storage device is expected; and
in a first instance of the first determination in which the identity of the second storage device is not expected:
concluding that the boot partition synchronization process is to be performed for the second storage device.

15. The non-transitory machine-readable medium of claim 14, wherein making the identification further comprises:
in a second instance of the first determination in which the identity of the second storage device is expected:
making a second determination regarding whether the second storage device comprises the boot data; and
in a first instance of the second determination in which the second storage device does not comprise the boot data:
concluding that the boot partition synchronization process is to be performed for the second storage device.

16. The non-transitory machine-readable medium of claim 13, wherein the boot data comprises at least one type of data selected from a list of types of data consisting of:
an image of a startup manager of the data processing system; and
system configuration files.

17. A data processing system, comprising:
a processor; and
a memory coupled to the processor to store instructions, which when executed by the processor, cause the processor to perform operations for managing operation of a data processing system, the operations comprising:
making an identification, by a management controller of the data processing system, that a first storage device of hardware resources of the data processing system has been replaced with a second storage device, and that boot data that was stored in a first boot partition of the first storage device is not stored in the second storage device;
based on the identification:
obtaining a copy of the boot data from a trusted entity;
initiating, by the management controller and via side band channels of the data processing system, performance of a boot partition synchronization process to store the copy of the boot data in a second boot partition of the second storage device;
using the copy of the boot data to place the data processing system in a desired operating state; and
providing, by the data processing system in the desired operating state, computer-implemented services.

18. The data processing system of claim 17, wherein making the identification comprises:
obtaining, by the management controller, an intrusion detection alert indicating that the first storage device has been replaced with the second storage device;
in response to the intrusion detection alert:
obtaining, by the management controller and via a first side band channel of the side band channels, identifying information from the second storage device;
making a first determination, by the management controller and using the identifying information, regarding whether an identity of the second storage device is expected; and
in a first instance of the first determination in which the identity of the second storage device is not expected:
concluding that the boot partition synchronization process is to be performed for the second storage device.

19. The data processing system of claim 18, wherein making the identification further comprises:
in a second instance of the first determination in which the identity of the second storage device is expected:
making a second determination regarding whether the second storage device comprises the boot data; and
in a first instance of the second determination in which the second storage device does not comprise the boot data:
concluding that the boot partition synchronization process is to be performed for the second storage device.

20. The data processing system of claim 17, wherein the boot data comprises at least one type of data selected from a list of types of data consisting of:
an image of a startup manager of the data processing system; and
system configuration files.
